(19) United States
(12) Patent Application Publication
(10) Pub. No.: US 2026/0212835 A1
(43) Pub. Date: Jul. 23, 2026

(54) PROJECTION DISPLAY DEVICE AND METHOD OF CONTROLLING PROJECTION DISPLAY DEVICE

(71) Applicant: JVCKENWOOD Corporation, Yokohama-shi (JP)

(72) Inventors: Naoya OKAMOTO, Yokohama-shi (JP); Shigeru Maruyama, Yokohama-shi (JP)

(21) Appl. No.: 19/572,009

(22) Filed: Mar. 19, 2026

Related U.S. Application Data
(63) Continuation of application No. PCT/JP2024/028171, filed on Aug. 7, 2024.

(30) Foreign Application Priority Data
Sep. 22, 2023 (JP) 2023-158432

(51) Int. Cl. G09G 3/36; G03B 21/00; G03B 21/20; G09G 3/02; G09G 3/20; H04N 9/31

(52) U.S. Cl. CPC G09G 3/3607; G03B 21/006; G03B 21/2066; G03B 21/2073; G09G 3/02; G09G 3/2092; H04N 9/3135; H04N 9/3182; G09G 2310/08; G09G 2320/0233; G09G 2320/0666; G09G 2360/16

(57) ABSTRACT

A re-entry illumination light intensity calculation unit is configured to calculate an intensity of re-entry illumination light, among first polarized lights entering a reflective liquid crystal display element in illumination light including first and second polarized lights, is reflected without being modulated by the reflective liquid crystal display element and returns to a light source unit side, is reflected and re-enters the reflective liquid crystal display element, and calculates a summed value obtained by summing the intensity of the re-entry illumination light of all pixels constituting a frame. A reference re-entry illumination light intensity storage unit stores a reference summed value of reference frame images. A light source control unit selects a reference summed value corresponding to any one of the reference frame images, compares the calculated summed value with the selected reference summed value, and controls a light emission amount from the light source unit.

### CROSS-REFERENCE TO RELATED APPLICATIONS

This application is a continuation of PCT Application No. PCT/JP2024/028171, filed on August 7, 2024, and claims the priority of Japanese Patent Application No. 2023-158432, filed on September 22, 2023, the entire contents of both of which are incorporated herein by reference.

### BACKGROUND

The present disclosure relates to a projection display device and a method of controlling a projection display device.

In a projection display device using a reflective liquid crystal display element as a light modulation element, from among illumination light incident on the reflective liquid crystal display element, illumination light other than modulation light that is modulated and reflected corresponding to an image to be displayed and directed toward a projection lens returns to an illumination optical system or a light source unit. The illumination light that has returned to the illumination optical system or the light source unit may be reflected within the illumination optical system or the light source unit and re-enter the reflective liquid crystal display element.

The illumination light, which returns to the illumination optical system or the light source unit from a certain pixel and re-enters the reflective liquid crystal display element by being reflected within the illumination optical system or the light source unit, does not enter the same certain pixel, but is irradiated onto the entire reflective liquid crystal display element. Therefore, when illumination light re-enters the reflective liquid crystal display element, the display luminance of each pixel of each frame changes under the influence of the pixel values of the entire frame.

As an example, first to third frames in which video data is 8 bits are compared. The first frame has a gray level of 128 over the entire frame. The second frame includes a region having a gray level of 128 at the center of the frame, and a periphery having a gray level of 0 (black). The third frame includes a region having a gray level of 128 at the center of the frame, and a periphery having a gray level of 255 (white). In this case, the display luminance of the first frame having a gray level of 128, the display luminance of the region having a gray level of 128 of the second frame, and the display luminance of the region having a gray level of 128 of the third frame are different from each other because the degree of influence due to re-entry of illumination light is different.

### SUMMARY

Japanese Unexamined Patent Application Publication No. 2015-118224 describes that, in order to compensate for the influence of re-entry illumination light, a gain is applied to any one of red (R), green (G), and blue (B) color data in video data to adjust the balance of R, G, and B. However, if the pixel value of each color data is close to the maximum value, the pixel value becomes the maximum value by applying the gain, causing what is known as blown-out highlights. In the method of applying a gain to color data, it is not possible to appropriately correct the change in display luminance.

A first aspect of one or more embodiments provides a projection display device including: a re-entry illumination light intensity calculation unit configured, for each pixel constituting a target frame for analyzing a video among frames in video data to be displayed on a reflective liquid crystal display element, to calculate an intensity of re-entry illumination light, which is a first polarized light that, among first polarized lights of illumination light including first and second polarized lights entering the reflective liquid crystal display element via a polarizing plate, is reflected without being modulated by the reflective liquid crystal display element and returns to a light source unit side of the polarizing plate, is reflected by an optical element located on the light source unit side of the polarizing plate or by the light source unit, and re-enters the reflective liquid crystal display element via the polarizing plate, and to calculate a summed value obtained by summing the intensity of the re-entry illumination light calculated for all pixels constituting the target frame; a reference re-entry illumination light intensity storage unit configured to store a reference summed value obtained by summing the intensity of the re-entry illumination light at all pixels when reference frame images from a minimum gray level to a maximum gray level are displayed on the reflective liquid crystal display element; and a light source control unit configured to control a light emission amount from a light source included in the light source unit by selecting a reference summed value corresponding to any one of the reference frame images based on the target frame, and comparing the summed value calculated by the re-entry illumination light intensity calculation unit with the selected reference summed value.

A second aspect of one or more embodiments provides a method of controlling a projection display device including: for each pixel constituting a target frame for analyzing a video among frames in video data to be displayed on a reflective liquid crystal display element, calculating an intensity of re-entry illumination light that is a first polarized light which, among first polarized lights of illumination light including first and second polarized lights entering the reflective liquid crystal display element via a polarizing plate, is reflected without being modulated by the reflective liquid crystal display element and returns to a light source unit side of the polarizing plate, is reflected by an optical element located on the light source unit side of the polarizing plate or by the light source unit, and re-enters the reflective liquid crystal display element via the polarizing plate, and calculating a summed value obtained by summing the intensity of the re-entry illumination light calculated for all pixels constituting the target frame; selecting, from among the reference summed values stored in a reference re-entry illumination light intensity storage unit and obtained by summing the intensity of the re-entry illumination light at all pixels when reference frame images from a minimum gray level to a maximum gray level are displayed on the reflective liquid crystal display element, a reference summed value corresponding to any one of the reference frame images based on the target frame; and controlling a light emission amount from a light source included in the light source unit by comparing the calculated summed value with the selected reference summed value.

### BRIEF DESCRIPTION OF THE DRAWINGS

FIG. 1 is a diagram illustrating a projection display device according to one or more embodiments.

FIG. 2 is a plan view and a side view illustrating a detailed configuration of a light source unit included in the projection display device according to one or more embodiments.

FIG. 3 is a diagram illustrating another type of reflective polarizing plate that can be used instead of a reflective polarizing plate in FIG. 1.

FIG. 4 is a block diagram illustrating a configuration example of an element/light source driving unit included in the projection display device according to one or more embodiments.

FIG. 5A is a characteristic diagram illustrating irradiation intensity of illumination light irradiated onto a light modulation element in a horizontal direction.

FIG. 5B is a characteristic diagram illustrating irradiation intensity of illumination light irradiated onto the light modulation element in a vertical direction.

FIG. 6A is a diagram illustrating a first delay time from a time point when the frame has switched from an immediately preceding frame to a current frame until video data of the current frame is displayed on the light modulation element, and a second delay time until a light source emits light with a light emission amount corresponding to the current frame.

FIG. 6B is a diagram illustrating delaying a timing of controlling a light source driving unit that drives the light source when the first delay time is longer than the second delay time.

FIG. 6C is a diagram illustrating delaying video data when the second delay time is longer than the first delay time.

FIG. 6D is a diagram illustrating a projection image on a screen being displayed with a delay by a delay time that varies between a minimum delay time and a maximum delay time.

FIG. 7A is a partial flowchart illustrating an operation of the projection display device according to one or more embodiments.

FIG. 7B is a partial flowchart illustrating the operation of the projection display device according to one or more embodiments, continuing from FIG. 7A.

FIG. 8A is a diagram illustrating a delay amount for video data set by a delay device when the first delay time is the minimum delay time in a preferable configuration example of the element/light source driving unit.

FIG. 8B is a diagram illustrating a delay amount for video data set by the delay device when the first delay time is an intermediate delay time between the minimum delay time and the maximum delay time in the preferable configuration example of the element/light source driving unit.

FIG. 8C is a diagram illustrating a delay amount for video data set by the delay device when the first delay time is the maximum delay time in the preferable configuration example of the element/light source driving unit.

FIG. 8D is a diagram illustrating a projection image on the screen being displayed after being delayed by a fixed delay time in the preferable configuration example of the element/light source driving unit.

### DETAILED DESCRIPTION

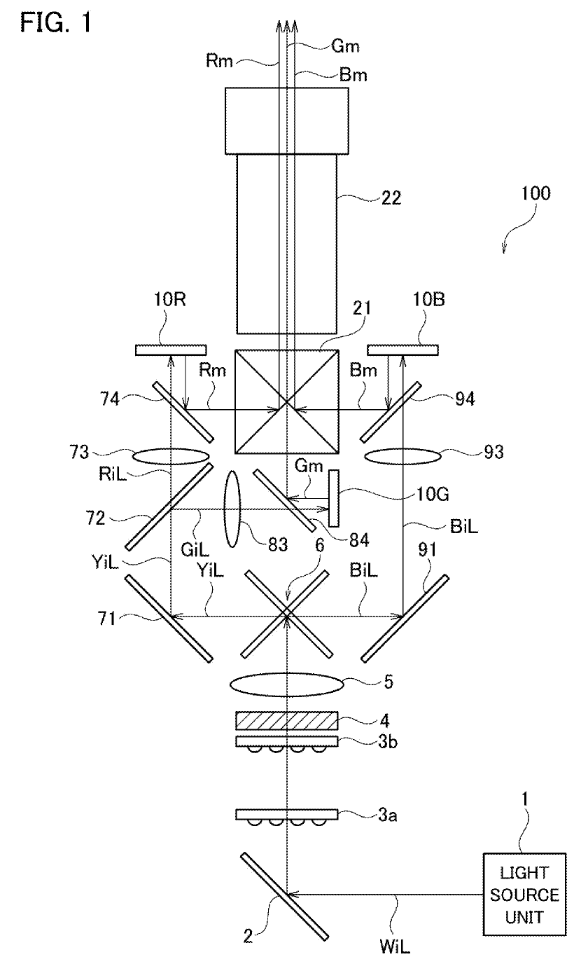

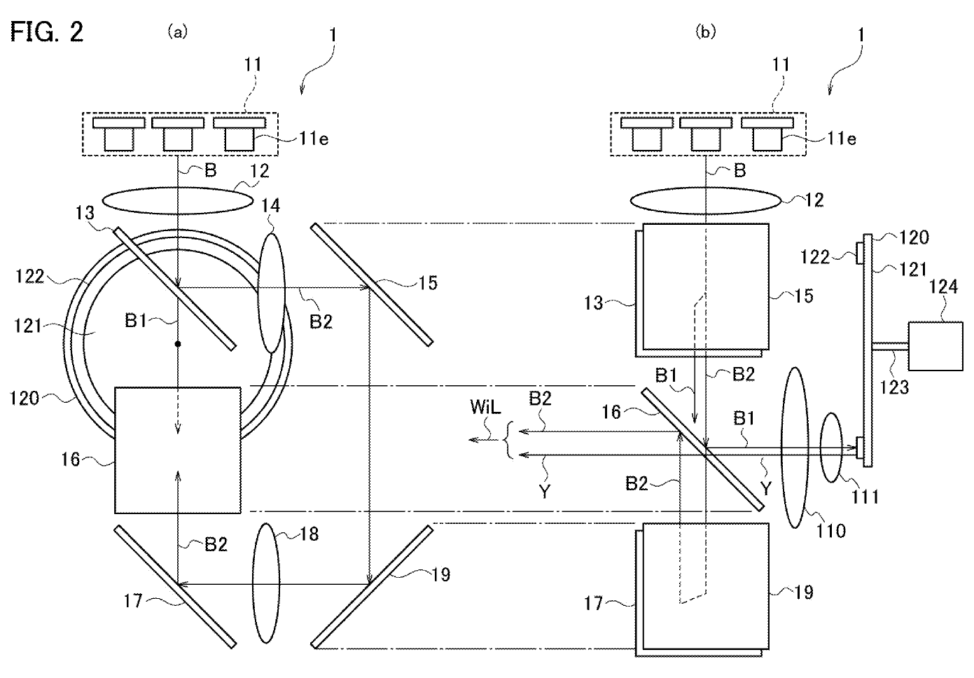

Hereinafter, a projection display device and a method of controlling the projection display device according to one or more embodiments will be described with reference to the accompanying drawings. In FIG. 1, a projection display device 100 according to one or more embodiments includes a light source unit 1 that emits white illumination light WiL. The light source unit 1 is configured as illustrated in FIG. 2. In FIG. 2, B (B1 and B2) and Y indicate blue light and yellow light, respectively.

In FIG. 2, the light source unit 1 includes a light source 11 including a plurality of blue laser elements 11e and a phosphor wheel 120. (a) in FIG. 2 is a front view of the light source unit 1, and (b) is a side view of the light source unit 1. Blue light emitted from the light source 11 is condensed by a condenser lens 12 and enters a splitting mirror 13. The splitting mirror 13 transmits a part (B1) of the incident blue light and reflects the remaining part (B2). Blue light (B2) reflected by the splitting mirror 13 is reflected by mirrors 15 and 19, condensed by a condenser lens 18, and reflected by a mirror 17.

Blue light (B2) reflected by the mirror 17 is reflected by a dichroic mirror 16. The dichroic mirror 16 has a characteristic of reflecting blue light and transmitting yellow light.

Blue light (B1) transmitted through the splitting mirror 13 is reflected by the dichroic mirror 16, condensed by condenser lenses 110 and 111, and directed toward the phosphor wheel 120. The phosphor wheel 120 is configured to rotate a mirror-like disk 121 around a rotation shaft 123 using a motor 124. A phosphor 122 is applied near an outer peripheral end of the disk 121. Blue light condensed by the condenser lenses 110 and 111 enters the phosphor 122, excites the phosphor 122, and emits yellow light including a red component and a green component.

Yellow light emitted from the phosphor 122 enters the dichroic mirror 16 via the condenser lenses 111 and 110. The dichroic mirror 16 transmits the yellow light. The blue light (B2) reflected by the dichroic mirror 16 as described above, and the yellow light transmitted through the dichroic mirror 16, are emitted from the light source unit 1 as the white illumination light WiL.

Returning to FIG. 1, the illumination light WiL emitted from the light source unit 1 is reflected by a mirror 2 and enters fly-eye lenses 3a and 3b. Each optical element from the mirror 2 to immediately before respective light modulation elements 10R, 10G, and 10B for red (R), green (G), and blue (B), which will be described below, constitutes an illumination optical system. The light modulation elements 10R, 10G, and 10B for R, G, and B will be referred to as R light modulation element 10R, G light modulation element 10G, and B light modulation element 10B, respectively. The R light modulation element 10R, the G light modulation element 10G, and the B light modulation element 10B may be collectively referred to as a light modulation element 10.

The R light modulation element 10R, the G light modulation element 10G, and the B light modulation element 10B are reflective liquid crystal display elements. That is, the R light modulation element 10R, the G light modulation element 10G, and the B light modulation element 10B are a reflective liquid crystal display element for red, a reflective liquid crystal display element for green, and a reflective liquid crystal display element for blue, respectively. The R light modulation element 10R, the G light modulation element 10G, and the B light modulation element 10B may be liquid crystal display elements generally called Liquid Crystal On Silicon (LCOS) elements.

The fly-eye lenses 3a and 3b make the illumination distribution of illumination light irradiated onto the R light modulation element 10R, the G light modulation element 10G, and the B light modulation element 10B, uniform. The illumination light WiL emitted from the fly-eye lens 3b enters a polarization conversion element 4. The polarization conversion element 4 aligns s-polarized light (first polarized light) and p-polarized light (second polarized light) included in the illumination light WiL to either one of the polarized lights. As an example, the polarization conversion element 4 transmits s-polarized light through a polarization beam splitter, converts p-polarized light reflected by the polarization beam splitter into s-polarized light by a half-wave plate, and emits the s-polarized light.

The s-polarized illumination light WiL emitted from the polarization conversion element 4 is condensed by a condenser lens 5 and enters a cross dichroic mirror 6. The cross dichroic mirror 6 separates the s-polarized illumination light WiL into yellow illumination light YiL and blue illumination light BiL.

The yellow illumination light YiL separated by the cross dichroic mirror 6 enters and is reflected by a mirror 71, and enters a dichroic mirror 72. The dichroic mirror 72 transmits red illumination light RiL included in the yellow illumination light YiL, and reflects green illumination light GiL included in the yellow illumination light YiL. The red illumination light RiL is condensed by a condenser lens 73 and enters a reflective polarizing plate 74. Here, the reflective polarizing plate 74 transmits s-polarized light and reflects p-polarized light. The reflective polarizing plate 74, and reflective polarizing plates 84 and 94 described below, can be configured with wire grids.

The R light modulation element 10R generates red modulated light Rm by modulating s-polarized red illumination light RiL entering via the reflective polarizing plate 74 according to red data (R data) in video data, and reflects the red modulated light Rm. The red modulated light Rm is p-polarized light, and the red modulated light Rm is reflected by the reflective polarizing plate 74 and enters a color combining prism 21.

The green illumination light GiL reflected by the dichroic mirror 72 is condensed by a condenser lens 83 and enters a reflective polarizing plate 84. Here, the reflective polarizing plate 84 transmits s-polarized light and reflects p-polarized light. The G light modulation element 10G generates green modulated light Gm by modulating s-polarized green illumination light GiL entering via the reflective polarizing plate 84 according to green data (G data) in the video data, and reflects the green modulated light Gm. The green modulated light Gm is p-polarized light, and the green modulated light Gm is reflected by the reflective polarizing plate 84 and enters the color combining prism 21.

The blue illumination light BiL separated by the cross dichroic mirror 6 enters and is reflected by a mirror 91, and enters a condenser lens 93. The blue illumination light BiL is condensed by the condenser lens 93 and enters a reflective polarizing plate 94. Here, the reflective polarizing plate 94 transmits s-polarized light and reflects p-polarized light.

The B light modulation element 10B generates blue modulated light Bm by modulating s-polarized blue illumination light BiL entering via the reflective polarizing plate 94 according to blue data (B data) in the video data, and reflects the blue modulated light Bm. The blue modulated light Bm is p-polarized light, and the blue modulated light Bm is reflected by the reflective polarizing plate 94 and enters the color combining prism 21.

The color combining prism 21 combines the red modulated light Rm, the green modulated light Gm, and the blue modulated light Bm to generate a full-color image. A projection lens 22 projects the full-color image onto an unillustrated screen.

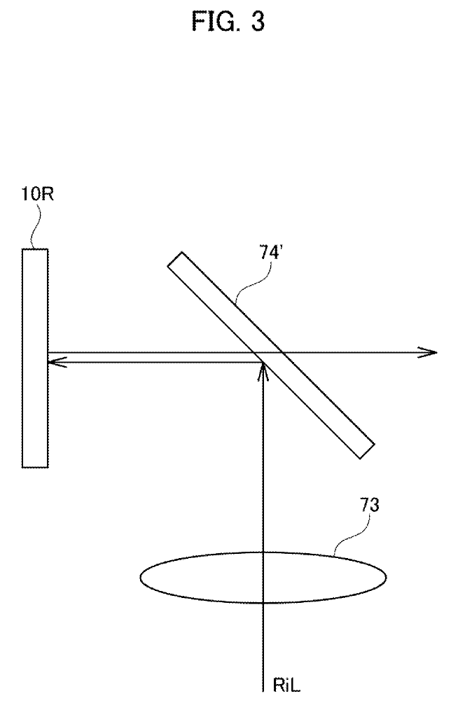

In the configuration example illustrated in FIG. 1, the reflective polarizing plate 74 that transmits s-polarized light and reflects p-polarized light is used. However, as illustrated in FIG. 3, a reflective polarizing plate 74' that reflects s-polarized light and transmits p-polarized light may be used instead of the reflective polarizing plate 74. The same applies to the reflective polarizing plates 84 and 94, and instead of the reflective polarizing plates 84 and 94 that transmit s-polarized light and reflect p-polarized light, reflective polarizing plates that reflect s-polarized light and transmit p-polarized light may be used.

The projection display device 100 described above is one configuration example of a projection display device, and the configuration of the light source unit 1 is not limited to the configuration illustrated in FIG. 2, and the configuration of the illumination optical system is not limited to the configuration illustrated in FIG. 1. The light source unit 1 may be configured to include a white lamp such as a mercury lamp as a light source. The projection display device 100 may be in any configuration that includes the R light modulation element 10R, the G light modulation element 10G, and the B light modulation element 10B, which are reflective liquid crystal display elements, and modulates the red illumination light RiL, the green illumination light GiL, and the blue illumination light BiL according to video data (R, G, B data) to generate a projection image.

In the projection display device 100, among s-polarized light entering the light modulation element 10, s-polarized light that is reflected without being modulated by the light modulation element 10 passes through the reflective polarizing plates 74, 84, and 94, and returns to the light source unit 1 side of the reflective polarizing plates 74, 84, and 94. The s-polarized light that is reflected without being modulated by the light modulation element 10 may return to the inside of the illumination optical system, be reflected by optical elements such as condenser lenses 73, 83, and 93 in the illumination optical system, and re-enter the light modulation element 10. The s-polarized light that is reflected without being modulated by the light modulation element 10 may return to the light source unit 1, be reflected, and re-enter the light modulation element 10.

If an image to be displayed on the screen is black and the pixel values of the R data, G data, and B data are 0, the s-polarized light entering the light modulation element 10 is not modulated by the light modulation element 10, so most of the s-polarized light returns to the light source unit 1 side. If an image to be displayed on the screen is gray, a part of the s-polarized light entering the light modulation element 10 is modulated by the light modulation element 10 and directed toward the projection lens 22, and the remaining part is not modulated by the light modulation element 10 and returns to the light source unit 1 side. If an image to be displayed on the screen is white and the pixel values of the R data, G data, and B data are the maximum values, most of the s-polarized light entering the light modulation element 10 is modulated by the light modulation element 10 and directed toward the projection lens 22.

Thus, how much s-polarized light among the s-polarized light entering the light modulation element 10 passes through the reflective polarizing plates 74, 84, and 94 and returns to the light source unit 1 side of the reflective polarizing plates 74, 84, and 94 varies depending on the image to be displayed on the screen. In addition, the intensity of re-entry illumination light, which is reflected by an optical element located on the light source unit 1 side of the reflective polarizing plates 74, 84, and 94, or by the light source unit 1, and re-enters the light modulation element 10 via the reflective polarizing plates 74, 84, and 94, varies depending on the image to be displayed on the screen.

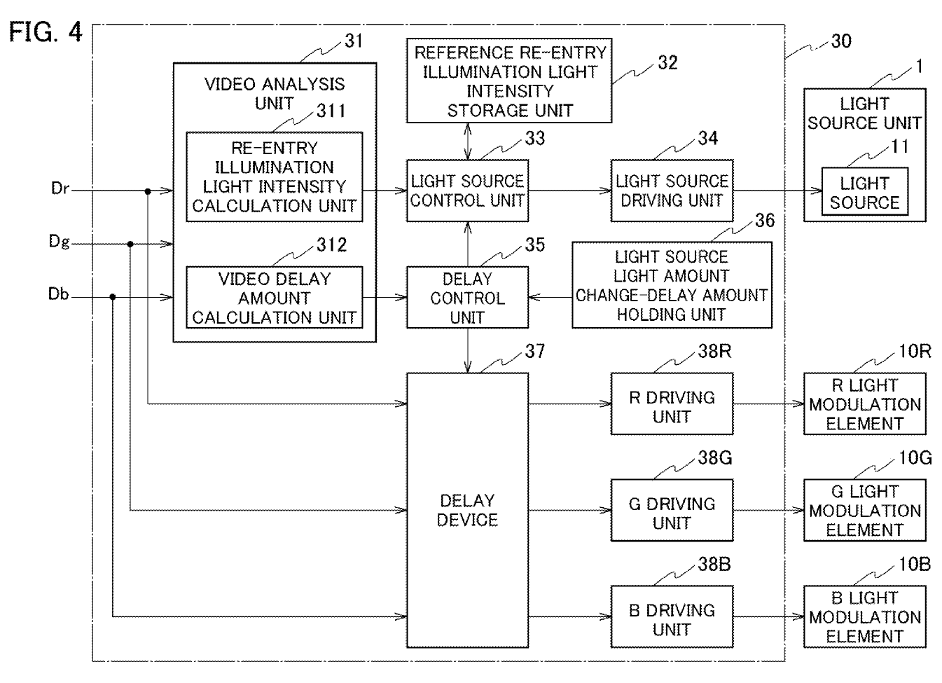

The projection display device 100 includes an element/light source driving unit 30 illustrated in FIG. 4, which is not illustrated in FIG. 1. As illustrated in FIG. 4, the element/light source driving unit 30 includes a video analysis unit 31, a reference re-entry illumination light intensity storage unit 32, a light source control unit 33, a light source driving unit 34, a delay control unit 35, a light source light amount change-delay amount holding unit 36, a delay device 37, a red driving unit (R driving unit) 38R, a green driving unit (G driving unit) 38G, and a blue driving unit (B driving unit) 38B. The video analysis unit 31 includes a re-entry illumination light intensity calculation unit 311 and a video delay amount calculation unit 312.

In FIG. 4, R data Dr, G data Dg, and B data Db constituting video data are input to the video analysis unit 31. The re-entry illumination light intensity calculation unit 311 calculates the intensity of re-entry illumination light by analyzing a video of a target frame. The re-entry illumination light, among the s-polarized light entering the light modulation element 10, is reflected without being modulated by the light modulation element 10, returns toward the light source unit 1, is reflected by an optical element in the illumination optical system or the light source unit 1, and re-enters the light modulation element 10. A target frame for analyzing a video may be each frame constituting the video data, or one frame for every two or more frames.

The re-entry illumination light intensity calculation unit 311 calculates the intensity of the re-entry illumination light based on pixel values of all pixels constituting the target frame in the video data, and calculates a summed value obtained by summing the intensity of the re-entry illumination light in the target frame. The re-entry illumination light intensity calculation unit 311 obtains a luminance value of each pixel of each frame based on a pixel value of each pixel in the R data Dr, a pixel value of each pixel in the G data Dg, and a pixel value of each pixel in the B data Db, and calculates the intensity and the summed value of the re-entry illumination light.

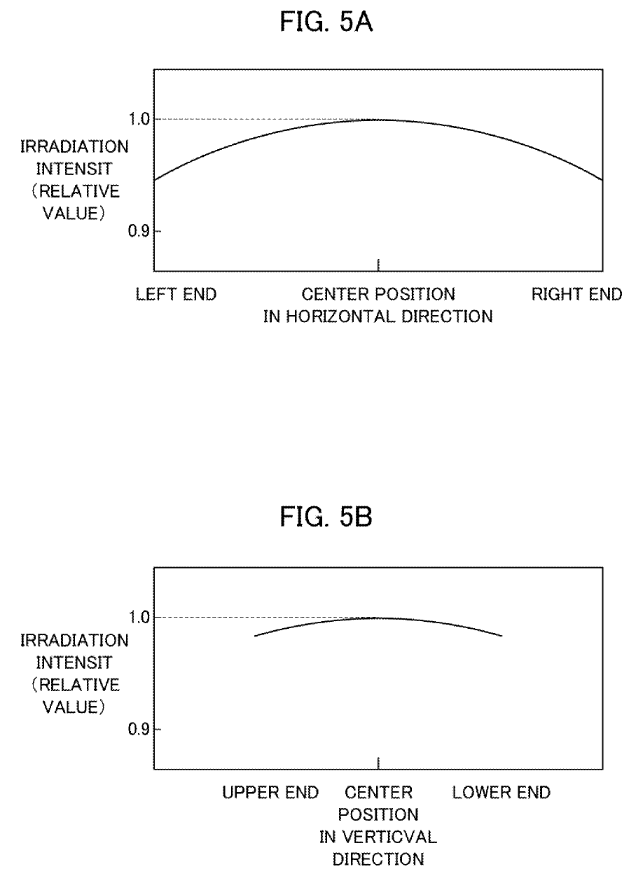

The ratio can be determined in advance through experiments between the intensity of the s-polarized light that is reflected without being modulated by the light modulation element 10, returns to the inside of the illumination optical system, is reflected by an optical element in the illumination optical system, and re-enters the light modulation element 10, and the intensity of the s-polarized light that returns to the light source unit 1, is reflected, and re-enters the light modulation element 10. The irradiation intensity of illumination light irradiated onto the light modulation element 10 is not uniform within a surface of the light modulation element 10, and, as illustrated in FIGS. 5A and 5B, is lower toward left and right ends in a horizontal direction and toward upper and lower ends in a vertical direction.

When s-polarized light that is reflected without being modulated by the light modulation element 10 returns to the light source unit 1 to be reflected, and re-enters the light modulation element 10, the s-polarized light is not affected by the characteristic of the irradiation intensity illustrated in FIGS. 5A and 5B. This is because the characteristic of the irradiation intensity is canceled by re-entry returning to the light source unit 1. When s-polarized light that is reflected without being modulated by the light modulation element 10 is reflected by an optical element in the illumination optical system and re-enters the light modulation element 10, the s-polarized light is affected by the characteristic of the irradiation intensity illustrated in FIGS. 5A and 5B.

Therefore, it is preferable that the re-entry illumination light intensity calculation unit 311 calculate the intensity of s-polarized light that is reflected by an optical element in the illumination optical system and re-enters the light modulation element 10, in consideration of the irradiation intensity at each position in the horizontal direction and the vertical direction in the s-polarized light entering the light modulation element 10.

The reference re-entry illumination light intensity storage unit 32 stores a reference summed value obtained by summing the intensity of re-entry illumination light at all pixels when a reference frame image is displayed on the screen (light modulation element 10). The reference frame image is a projection image in which each pixel in the R data Dr, the G data Dg, and the B data Db constituting a frame has a uniform pixel value at each gray level from a minimum gray level to a maximum gray level over the entire target frame, for example.

The light source control unit 33 compares the summed value of the re-entry illumination light calculated by the re-entry illumination light intensity calculation unit 311 with the reference summed value of the selected reference frame image to control the light emission amount by the light source 11 in the light source unit 1. Specifically, the light source control unit 33 determines a drive current value for controlling the light emission amount of the blue laser elements 11e in the light source 11. The light source driving unit 34 drives the light source 11 to pass a current of the drive current value determined by the light source control unit 33 to each blue laser element 11e.

The light source control unit 33 may select a reference frame image as follows. As a first example, the light source control unit 33 sets a center pixel of the target frame in the video data as a representative pixel, and selects a reference frame image having the same pixel value as the pixel value of the representative pixel. If the summed value of the re-entry illumination light supplied from the re-entry illumination light intensity calculation unit 311 is larger than the reference summed value of the reference frame image, the light source control unit 33 lowers the drive current value, and if the summed value of the re-entry illumination light is smaller than the reference summed value of the reference frame image, the light source control unit 33 raises the drive current value. In the first example, the brightness at the center of each frame of the video data can be accurately corrected.

As a second example, the light source control unit 33 divides the target frame in the video data into a plurality of sections, sets a center pixel of each section as a representative pixel, and selects a reference frame image having the same pixel value as an average value of pixel values of the plurality of representative pixels. If the summed value of the re-entry illumination light supplied from the re-entry illumination light intensity calculation unit 311 is larger than the reference summed value of the reference frame image, the light source control unit 33 lowers the drive current value, and if the summed value of the re-entry illumination light is smaller than the reference summed value of the reference frame image, the light source control unit 33 raises the drive current value. In the second example, it is possible to correct the brightness appropriately over each entire frame.

The method by which the light source control unit 33 selects a reference frame image is not limited to the first example or the second example. The light source control unit 33 may set a region of interest having a predetermined size at a central portion of the target frame and select a reference frame image having the same pixel value as an average value of pixel values of all pixels in the region of interest. In this way, the light source control unit 33 may select any one method from a plurality of methods for selecting a reference frame image.

Thus, in the element/light source driving unit 30, a change in display luminance caused by re-entry of illumination light to the light modulation element 10 is corrected by controlling the light emission amount of the light source 11 using the light source control unit 33. According to this correction method, unlike the method of applying a gain to color data (R data Dr, G data Dg, and B data Db), a pixel value does not become a maximum value to cause blown-out highlights. Therefore, the projection display device 100 can appropriately correct a change in display luminance by including the element/light source driving unit 30.

Incidentally, when a frame displayed on the R light modulation element 10R, the G light modulation element 10G, and the B light modulation element 10B is switched, it is desirable that a timing at which the light emission amount actually switches by the light source driving unit 34 driving to switch the light emission amount of the light source 11, matches a timing at which a video is actually displayed on the R light modulation element 10R, the G light modulation element 10G, and the B light modulation element 10B.

There is a delay time of a predetermined time amount between a time point at which the light source driving unit 34 switches from a drive current value of the immediately preceding frame to a drive current value of the current frame in response to switching of a frame, and a time point at which the drive current value flowing through the blue laser element 11e actually changes and the light emission amount changes. This delay time is a fixed time amount. In the light modulation element 10, a response characteristic when an applied voltage changes differs depending on liquid crystal characteristics. It may take a response time of about several ms until the luminance of an image displayed on the screen changes after a frame displayed on the light modulation element 10 is switched. Furthermore, the response time changes depending on how the luminance value changes from the immediately preceding frame to the current frame. Typically, the larger the difference in luminance value between the immediately preceding frame and the current frame, the longer the response time.

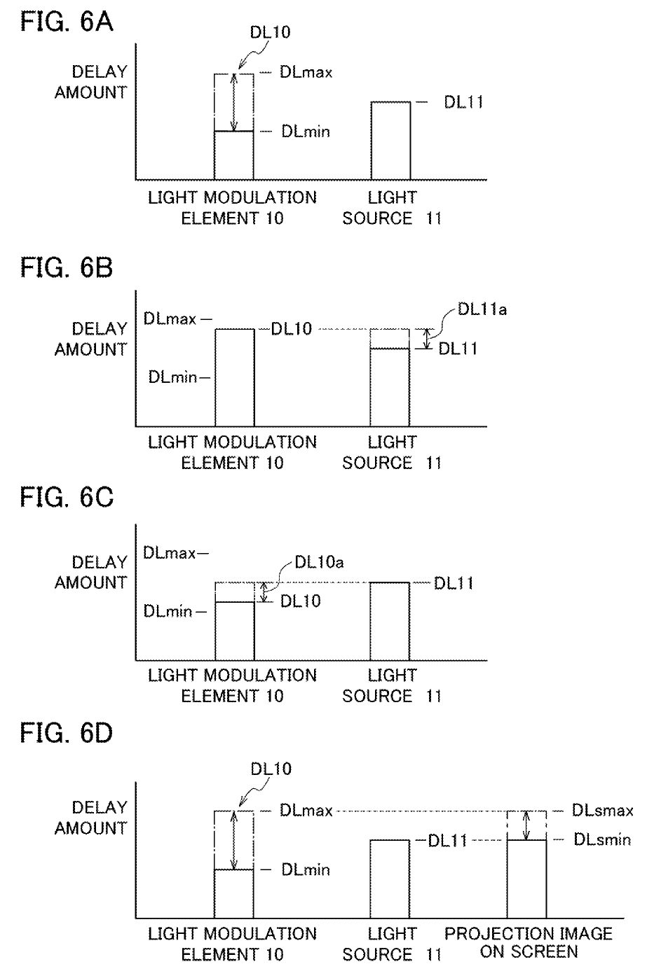

A delay time resulting from the response time of the light modulation element 10 from a time point when a frame of the video data is switched from the immediately preceding frame to the current frame until a video of the current frame is displayed on the light modulation element 10 is a first delay time DL10 illustrated in FIG. 6A. As illustrated in FIG. 6A, the first delay time DL10 varies in a range from a minimum delay time DLmin to a maximum delay time DLmax. The video delay amount calculation unit 312 calculates the first delay time DL10 by comparing the immediately preceding frame and the current frame.

A fixed delay time from a time point when a frame displayed on the light modulation element 10 is switched from the immediately preceding frame to the current frame until the light source 11 emits light with a light emission amount corresponding to the current frame is a second delay time DL11 illustrated in FIG. 6A. The first delay time DL10 and the second delay time DL11 are usually not the same.

The light source light amount change-delay amount holding unit 36 holds the second delay time DL11 measured in advance. The light source light amount change-delay amount holding unit 36 can be configured with a non-volatile memory, for example. The delay control unit 35 compares the first delay time DL10 calculated by the video delay amount calculation unit 312 with the second delay time DL11 held in the light source light amount change-delay amount holding unit 36 every time a frame is switched. The R data Dr, the G data Dg, and the B data Db are supplied to the R driving unit 38R, the G driving unit 38G, and the B driving unit 38B via the delay device 37, respectively.

As illustrated in FIG. 6B, if the first delay time DL10 is longer than the second delay time DL11, the delay control unit 35 sets a delay amount in the delay device 37 to 0, and delays a timing at which the light source control unit 33 controls the light source driving unit 34 for driving the light source 11 by a time DL11a, so that the light source 11 emits light with a light emission amount corresponding to the current frame. The delay control unit 35 delays the timing of controlling the light source driving unit 34 to bring a timing at which a video of the current frame is displayed on the light modulation element 10, and a timing at which the light source 11 emits light with a light emission amount corresponding to the current frame, closer. As illustrated in FIG. 6B, it is preferable that the delay control unit 35 delays the timing of controlling the light source driving unit 34 so that the timing at which a video of the current frame is displayed on the light modulation element 10 match the timing at which the light source 11 emits light with a light emission amount corresponding to the current frame.

As illustrated in FIG. 6C, if the second delay time DL11 is longer than the first delay time DL10, the delay control unit 35 controls the delay amount in the delay device 37 to be a time DL10a exceeding 0, and delays the R data Dr, the G data Dg, and the B data Db by the delay device 37. The delay control unit 35 controls the delay amount provided by the delay device 37 to bring the timing at which a video of the current frame is displayed on the light modulation element 10, and the timing at which the light source 11 emits light with a light emission amount corresponding to the current frame, closer. As illustrated in FIG. 6C, it is preferable that the delay control unit 35 controls the delay amount provided by the delay device 37 so that the timing at which a video of the current frame is displayed on the light modulation element 10 match the timing at which the light source 11 emits light with a light emission amount corresponding to the current frame.

In this way, the delay control unit 35 preferably controls the delay amount provided by the delay device 37 so that the timing at which a video of the current frame is displayed on the light modulation element 10 matches the timing at which the light source 11 emits light with a light emission amount corresponding to the current frame, and controls the timing at which the light source control unit 33 controls the light source driving unit 34. Then, as illustrated in FIG. 6D, a projection image is displayed on the screen while being delayed by a delay time varying between a minimum delay time DLsmin, corresponding to the second delay time DL11, and a maximum delay time DLsmax, corresponding to the maximum delay time DLmax of the first delay time DL10. According to the method of controlling the light source control unit 33 and the delay device 37 by the delay control unit 35 illustrated in FIG. 6D, the length of a frame of the projection image displayed on the screen varies slightly.

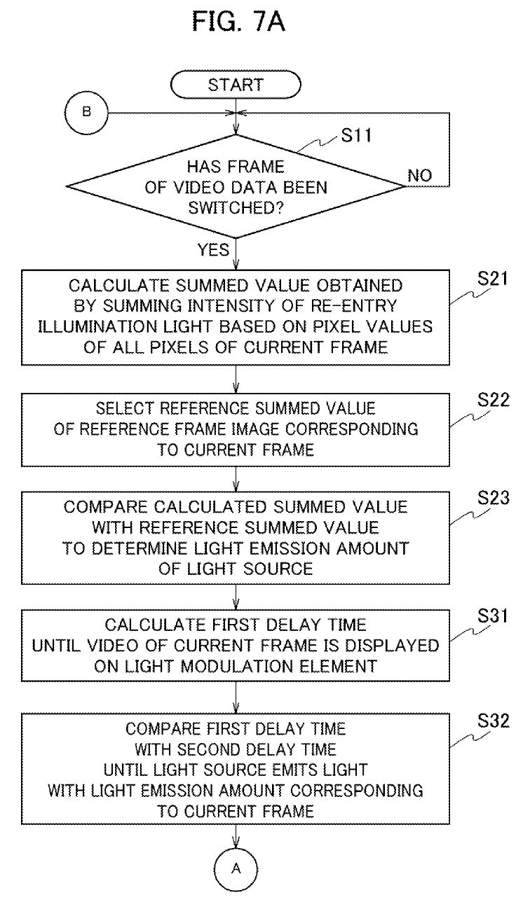

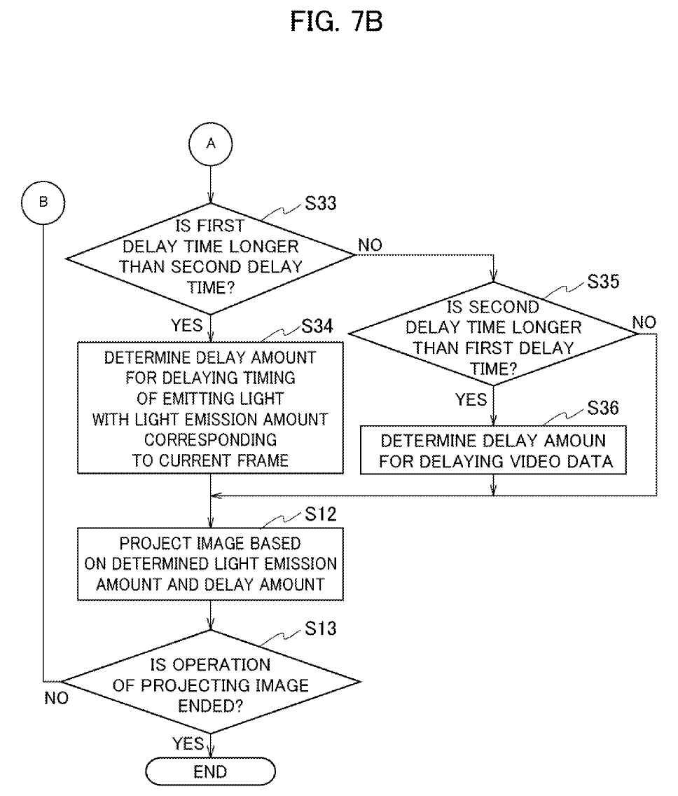

An operation of the projection display device 100 and a method of controlling the projection display device that the projection display device 100 (element/light source driving unit 30) executes will be further described using the flowcharts illustrated in FIGS. 7A and 7B. Each frame is set as a target frame in FIGS. 7A and 7B. When video data is input to the projection display device 100 and processing is started in FIG. 7A, the video analysis unit 31 determines whether or not a frame of the video data has been switched in step S11. If a frame of the video data has not been switched (NO), the video analysis unit 31 repeats the processing of step S11.

If a frame of the video data has been switched in step S11 (YES), the re-entry illumination light intensity calculation unit 311 calculates a summed value obtained by summing the intensity of the re-entry illumination light based on pixel values of all pixels of the current frame in step S21. The light source control unit 33 selects a reference summed value of the reference frame image corresponding to the current frame in step S22. The light source control unit 33 compares the summed value calculated in step S21 with the reference summed value selected in step S22 to determine the light emission amount of the light source 11 in step S23.

The video delay amount calculation unit 312 calculates the first delay time DL10 until a video of the current frame is displayed on the light modulation element 10 in step S31. The delay control unit 35 compares the first delay time DL10 with the second delay time DL11 until the light source 11 emits light with a light emission amount corresponding to the current frame in step S32. In FIG. 7B, the delay control unit 35 determines whether or not the first delay time DL10 is longer than the second delay time DL11 in step S33. If the first delay time DL10 is longer than the second delay time DL11 (YES), the delay control unit 35 determines a delay amount for delaying a timing of emitting light with a light emission amount corresponding to the current frame in step S34, and shifts the processing to step S12.

If the first delay time DL10 is not longer than the second delay time DL11 in step S33 (NO), the delay control unit 35 determines whether or not the second delay time DL11 is longer than the first delay time DL10 in step S35. If the second delay time DL11 is longer than the first delay time DL10 (YES), the delay control unit 35 determines a delay amount for delaying the video data in step S36 and shifts the processing to step S12. If the second delay time DL11 is not longer than the first delay time DL10 (NO), the delay control unit 35 shifts the processing to step S12.

The element/light source driving unit 30 drives the light source unit 1 and the light modulation element 10 to project an image onto the screen based on the determined light emission amount and delay amount in step S12, and shifts the processing to step S13. The element/light source driving unit 30 determines whether or not to end an operation of projecting an image onto the screen in step S13. If the operation of projecting an image onto the screen is not ended (NO), the element/light source driving unit 30 repeats the processing from step S11 illustrated in FIG. 7A onward. If the operation of projecting an image onto the screen is ended (YES), the element/light source driving unit 30 ends the processing.

In FIGS. 7A and 7B, the processing of steps S31 to S36 is provided after the processing of steps S21 to S23, but the order may be reversed, and the processing of steps S21 to S23 and the processing of steps S31 to S36 may be executed in parallel.

In FIGS. 6B and 6C, the delay control unit 35 controls either one of the delay amount provided by the delay device 37 and the timing at which the light source control unit 33 controls the light source driving unit 34 based on a comparison result between the first delay time DL10 and the second delay time DL11. Thereby, the timing at which a video of the current frame is displayed on the light modulation element 10 and the timing at which the light source 11 emits light with a light emission amount corresponding to the current frame are matched. Both the delay amount provided by the delay device 37, and the timing at which the light source control unit 33 controls the light source driving unit 34, may be controlled to match the timing at which a video of the current frame is displayed on the light modulation element 10, with the timing at which the light source 11 emits light with a light emission amount corresponding to the current frame.

The delay control unit 35 may control at least one of the delay amount provided by the delay device 37, or the timing at which the light source control unit 33 controls the light source driving unit 34, to match the timing at which a video of the current frame is displayed on the light modulation element 10, with the timing at which the light source 11 emits light with a light emission amount corresponding to the current frame.

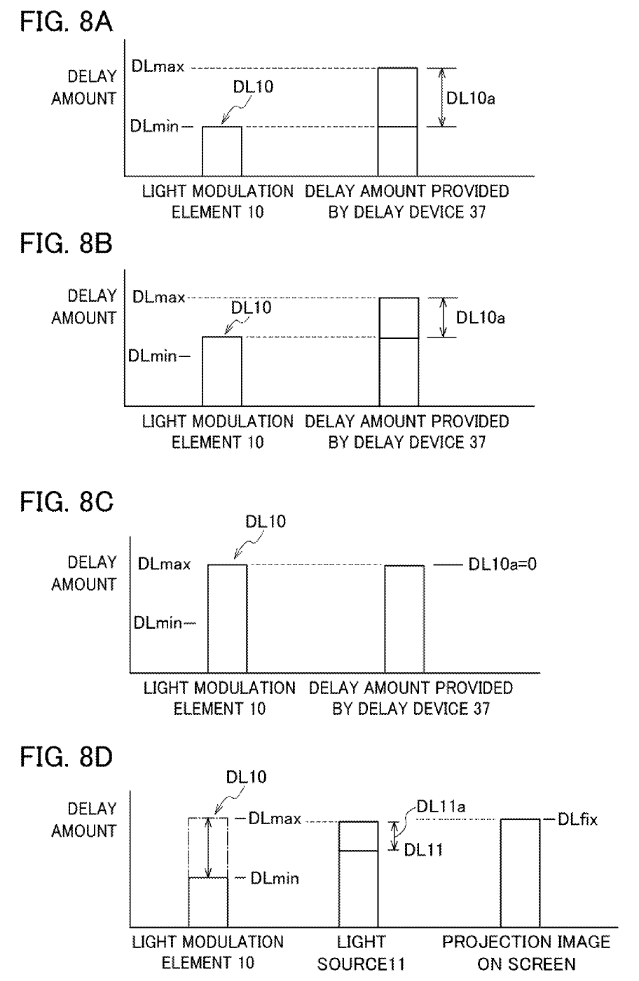

Furthermore, a preferable configuration example of the element/light source driving unit 30 will be described. It is preferable that the delay control unit 35 controls the delay amount provided by the delay device 37 and the timing at which the light source control unit 33 controls the light source driving unit 34 as follows. FIG. 8A illustrates a case where the first delay time DL10 is the minimum delay time DLmin. The delay control unit 35 controls the delay device 37 to delay the video data by the time DL10a corresponding to a difference between the maximum delay time DLmax and the minimum delay time DLmin that is the first delay time DL10 at that point. The delay time DL10a at this time is the maximum delay time.

FIG. 8B illustrates a case where the first delay time DL10 is an intermediate delay time between the minimum delay time DLmin and the maximum delay time DLmax. The delay control unit 35 controls the delay device 37 to delay the video data by the time DL10a corresponding to a difference between the maximum delay time DLmax and the intermediate delay time that is the first delay time DL10 at that time. The delay time DL10a at this time is a time shorter than the maximum delay time of the delay time DL10a in FIG. 8A.

FIG. 8C illustrates a case where the first delay time DL10 is the maximum delay time DLmax. The time DL10a corresponding to a difference between the maximum delay time DLmax and the maximum delay time DLmax that is the first delay time DL10 at that time is 0. Therefore, the delay control unit 35 sets the delay amount provided by the delay device 37 to 0.

In this way, the delay control unit 35 delays the video data using the delay device 37 by a time corresponding to a difference between the maximum delay time DLmax and the first delay time DL10 in each frame. The delay amount of the video data may be 0.

As illustrated in FIG. 8D, the delay control unit 35 controls the light source control unit 33 to delay the timing of controlling the light source driving unit 34 that drives the light source 11 to emit light with a light emission amount corresponding to the current frame by the time DL11a corresponding to a difference between the maximum delay time DLmax and the second delay time DL11. Then, as illustrated in FIG. 8D, a projection image is displayed on the screen delayed by a fixed delay time DLfix corresponding to the maximum delay time DLmax, regardless of what delay time the first delay time DL10 is between the minimum delay time DLmin and the maximum delay time DLmax.

According to the method of controlling the light source control unit 33 and the delay device 37 by the delay control unit 35 in the preferable configuration example of the element/light source driving unit 30 illustrated in FIGS. 8A to 8D, the length of a frame of a projection image displayed on the screen can be kept constant. Therefore, according to the preferable configuration example of the element/light source driving unit 30, the quality of a projection image displayed on the screen can be improved.

The video analysis unit 31, the light source control unit 33, and the delay control unit 35 may be constituted by one or more processors and one or more memories. Each of the processors may be a central processing unit (CPU) or a micro-processing unit (MPU). The one or more memories store one or more computer programs including computer-readable instructions. Each of the processors reads and executes the computer programs stored in the one or more memories to perform the processing operations assigned thereto. Each of the memories may include one or more of a non-volatile memory, a volatile memory, and other storage media. The one or more processors and the one or more memories may be implemented as dedicated hardware, or as a common hardware platform on which the respective functions are implemented by software.

The present invention is not limited to one or more embodiments described above, and can be modified in various ways without departing from the scope of the present invention.

What is claimed is:

1. A projection display device comprising:
a re-entry illumination light intensity calculation unit configured, for each pixel constituting a target frame for analyzing a video among frames in video data to be displayed on a reflective liquid crystal display element, to calculate an intensity of re-entry illumination light, which is a first polarized light that, among first polarized lights of illumination light including first and second polarized lights entering the reflective liquid crystal display element via a polarizing plate, is reflected without being modulated by the reflective liquid crystal display element and returns to a light source unit side of the polarizing plate, is reflected by an optical element located on the light source unit side of the polarizing plate or by the light source unit, and re-enters the reflective liquid crystal display element via the polarizing plate, and to calculate a summed value obtained by summing the intensity of the re-entry illumination light calculated for all pixels constituting the target frame;
a reference re-entry illumination light intensity storage unit configured to store a reference summed value obtained by summing the intensity of the re-entry illumination light at all pixels when reference frame images from a minimum gray level to a maximum gray level are displayed on the reflective liquid crystal display element; and
a light source control unit configured to control a light emission amount from a light source included in the light source unit by selecting a reference summed value corresponding to any one of the reference frame images based on the target frame, and comparing the summed value calculated by the re-entry illumination light intensity calculation unit with the selected reference summed value.

2. The projection display device according to claim 1, further comprising:
a video delay amount calculation unit configured to calculate a first delay time from a time point when a frame to be displayed on the reflective liquid crystal display element in the video data is switched from an immediately preceding frame to a current frame until a video of the current frame is displayed on the reflective liquid crystal display element;
a delay device configured to delay the video data to be supplied to the reflective liquid crystal display element; and
a delay control unit configured to control at least one of a delay amount for delaying the video data by the delay device, or a timing of controlling, by the light source control unit, a light source driving unit that drives the light source to emit light with a light emission amount corresponding to the current frame, so as to match a timing at which a video of the current frame is displayed on the reflective liquid crystal display element with a timing at which the light source emits light with a light emission amount corresponding to the current frame, based on a comparison result obtained by comparing the first delay time with a second delay time, the second delay time being from a time point when a frame to be displayed on the reflective liquid crystal display element in the video data is switched from an immediately preceding frame to a current frame until the light source emits light with a light emission amount corresponding to the current frame.

3. The projection display device according to claim 1, further comprising:
a video delay amount calculation unit configured to calculate a first delay time that varies in a range from a minimum delay time to a maximum delay time from a time point when a frame to be displayed on the reflective liquid crystal display element in the video data is switched from an immediately preceding frame to a current frame until a video of the current frame is displayed on the reflective liquid crystal display element;
a delay device configured to delay the video data to be supplied to the reflective liquid crystal display element; and
a delay control unit configured to control the delay device to delay the video data by a time corresponding to a difference between the maximum delay time and the first delay time, and control the light source control unit to delay, by a time corresponding to a difference between the maximum delay time and a second delay time, a timing of controlling a light source driving unit that drives the light source to emit light with a light emission amount corresponding to the current frame, the second delay time being from a time point when a frame to be displayed on the reflective liquid crystal display element in the video data is switched from an immediately preceding frame to a current frame until the light source emits light with a light emission amount corresponding to the current frame.

4. The projection display device according to claim 1, wherein the re-entry illumination light intensity calculation unit is configured to calculate the intensity of the re-entry illumination light, in consideration of an irradiation intensity at each position in a horizontal direction and a vertical direction in the first polarized light that is reflected by the optical element and re-enters the reflective liquid crystal display element.

5. A method of controlling a projection display device comprising:
for each pixel constituting a target frame for analyzing a video among frames in video data to be displayed on a reflective liquid crystal display element, calculating an intensity of re-entry illumination light that is a first polarized light which, among first polarized lights of illumination light including first and second polarized lights entering the reflective liquid crystal display element via a polarizing plate, is reflected without being modulated by the reflective liquid crystal display element and returns to a light source unit side of the polarizing plate, is reflected by an optical element located on the light source unit side of the polarizing plate or by the light source unit, and re-enters the reflective liquid crystal display element via the polarizing plate, and calculating a summed value obtained by summing the intensity of the re-entry illumination light calculated for all pixels constituting the target frame;
selecting, from among the reference summed values stored in a reference re-entry illumination light intensity storage unit and obtained by summing the intensity of the re-entry illumination light at all pixels when reference frame images from a minimum gray level to a maximum gray level are displayed on the reflective liquid crystal display element, a reference summed value corresponding to any one of the reference frame images based on the target frame; and
controlling a light emission amount from a light source included in the light source unit by comparing the calculated summed value with the selected reference summed value.
